(19) United States
(12) Patent Application Publication
(10) Pub. No.: US 2011/0202692 A1
(43) Pub. Date: Aug. 18, 2011

(54) COMPUTER PERIPHERAL APPARATUS

(75) Inventors: Chi-Tung Chang, Taipei (TW); I-Chieh Lin, Taipei (TW)

(73) Assignee: Alcor Micro Corp., Taipei (TW)

(21) Appl. No.: 12/758,821

(22) Filed: Apr. 13, 2010

(30) Foreign Application Priority Data
Feb. 12, 2010 (TW) 099104595

(51) Int. Cl. G06F 3/00

(52) U.S. Cl. 710/16

(57) ABSTRACT

The present invention discloses a computer peripheral apparatus. The computer peripheral apparatus includes an USB hub, at least one build-in card reader, and a controller. Each build-in card reader is electrically connected to one built-in downstream port of the USB hub. The controller connects to the USB hub and the build-in card reader to monitor the connection requirement of the build-in card reader. When the controller determines the build-in card reader does not need to be kept connected, the controller sets the status of its corresponding built-in downstream port as a “first status,” which defines the corresponding built-in downstream port is not connected. Thus, the computer system is informed that the built-in downstream port is not connected. Therefore, if there are no USB devices connecting to other downstream ports of the USB hub, the entire computer peripheral apparatus can enter into hibernation mode, thereby lowering the power consumption

### BACKGROUND OF THE INVENTION

1. Technical Field

The present invention relates to computer peripheral apparatuses, and more particularly, to a computer peripheral apparatus including at least one build-in card reader that is capable of lowering the power consumption when it is not necessary for the build-in card reader to keep connection.

2. Description of Related Art

USB (Universal Serial Bus) technology provides a standard simplifying diverse wires and connectors for the connection between external peripheral apparatuses and host computers. Through transmission lines connected between USB ports associated with various peripheral apparatuses and host computers, the connection can be established with fewer wires and connectors. Furthermore, the USB port supports the plug-and-play function, which allows the peripheral apparatuses to be installed and used at any time without rebooting the host computers.

While it is desirable to provide more USB ports than can be supported by the chip set of the host computer, a USB hub may be built in the host computer. Moreover, for improving convenience, many computer peripheral apparatuses have been developed that integrate USB hubs therein, such as multi-function keyboards, mice, card readers, display devices, and more.

FIG. 1 depicts the structure of a conventional computer peripheral apparatus 100 with a built-in USB hub 10. FIG. 2 shows an external USB device 21 connected to the computer peripheral apparatus 100 through the built-in USB hub 10.

As shown in FIG. 1, the computer peripheral apparatus 100 with the built-in USB hub 10 includes the USB hub 10 and a build-in card reader 11. The USB hub 10 has a hub controlling unit 12, an upstream USB port 13, a plurality of downstream USB ports 14, and at least one built-in downstream port 15.

The build-in card reader 11 includes a card-reader controlling unit 111, a connector 112, and a card slot 113. The card slot 113 serves to receive external cards, such as memory cards, chip cards, and so on. The memory card or chip card inserted into the card slot 113 can thereby be connected to the card-reader controlling unit 111 through the connector 112.

Therein, the upstream USB port 13 acts as an interface between the host computer 20 and the USB hub 10 for transmitting signals The downstream USB ports 14 are configured to connect said external USB devices 21. The built-in downstream port 15 is connected to the card-reader controlling unit 111 in the build-in card reader 11, so that the build-in card reader 11 and the USB hub 10 are integrated in the computer peripheral apparatus 100, and the build-in card reader 11 can transmit signals through the USB hub 10.

Furthermore, the upstream USB port 13 and the downstream USB ports 14 are all electrically connected to the hub controlling unit 12. The hub controlling unit 12 includes a plurality of registers R₁, R₂, R₃, and R₄. Each of these registers R₁, R₂, R₃, and R₄ is respectively connected to one said downstream USB port 14 and also the built-in downstream port 15, for recording whether the downstream USB port 14 and/or the built-in downstream port 15 are connected.

Therefore, although the built-in downstream port 15 does not have a physical mechanism to receive the USB device 21, the hub controlling unit 12 regards the built-in downstream port 15 as nothing different from the downstream USB port 14. Basically, to the USB hub 10 in the computer peripheral apparatus 100, the build-in card reader 11 and the external USB device 21 play the same role.

By comparing FIG. 1 and FIG. 2 where the different statuses of the registers R₁, R₂, R₃, and R₄ in the hub controlling unit 12 are shown, it can be noted that values of the registers R₁, R₂, R₃, and R₄ represent whether the downstream USB ports 14 and the built-in downstream port 15 are connected, wherein the value of 1 indicates that the corresponding downstream USB port 14 and the built-in downstream port 15 are connected, while the value of 0 indicates that the corresponding downstream USB port 14 and the built-in downstream port 15 are not connected. Thus, when the USB device 21 is connected to the downstream USB port 14, the value of the corresponding register R₃ accordingly becomes 1 from 0, so as to inform the host computer 20 of the established connection at the downstream USB port 14 caused by the USB device 21, thereby enabling signal transmission between the USB device 21 and the host computer 20.

However, in the computer peripheral apparatus 100 incorporating the USB hub 10, the built-in downstream port 15 of the USB hub 10 always remains connected with the build-in card reader 11, which cannot be signally absent from the USB hub 10. As the built-in card reader 11 cannot be removed, when it is idle and does not need to be connected, the register R₁ corresponding to the built-in downstream port 15 maintains its value as 1, and the computer peripheral apparatus 100 awaits the next transmission task. Furthermore, the host computer 20 cannot put the computer peripheral apparatus 100 and the corresponding USB port of the host computer in hibernation, a problem that causes unnecessary power consumption when the build-in card reader 11 is not used.

### BRIEF SUMMARY OF THE INVENTION

The present invention provides a computer peripheral apparatus, which uses a controller to monitor a connection requirement from a build-in card reader and informs in real-time a host computer of whether the connection requirement exists, so that when there is neither a card nor an external USB device connected to the computer peripheral apparatus, the computer peripheral apparatus can enter hibernation mode to conserve power.

The present invention provides a computer peripheral apparatus, which detects a connection requirement of a build-in card reader, so as to timely enter hibernation mode for lowering power consumption when there is not a connection requirement.

To achieve the above effects, the present invention provides a computer peripheral apparatus, which integrates at least one build-in card reader and a USB hub. The computer peripheral apparatus comprises: the USB hub having an upstream USB port, at least one downstream USB port and at least one built-in downstream port; the at least one build-in card reader, each electrically connected to one said built-in downstream port; and a controller electrically connected to and controlling the USB hub and the build-in card reader, monitoring the connection requirement of each said build-in card reader, and such operation that when determining that there is no connection requirement from one said build-in card reader, the controller sets the corresponding built-in downstream port as a first status and compels the built-in downstream port to be recognized as not connected; and when that determining there is a connection requirement from one said build-in card reader, the controller sets the corresponding built-in downstream port as a second status and compels the built-in downstream port to be recognized as connected.

By implementing the present invention, at least the following progressive effects can be achieved:

1. The controller monitors the connection requirement from the build-in card reader, so that when there is neither a card connected to the build-in card reader nor an external USB device connected to the downstream USB port of the computer peripheral apparatus, the computer peripheral apparatus is released from connection, thereby lowering the power consumption of the idle computer peripheral apparatus.

2. The computer peripheral apparatus of the present invention is adaptive to any existing host computer without modifying any hardware, software, or driver of the host computer, thereby achieving the purpose of conserving power conveniently and economically.

### BRIEF DESCRIPTION OF THE DRAWINGS

The invention as well as a preferred mode of use and advantages thereof will be best understood by referring to the following detailed description of the illustrative embodiments in conjunction with the accompanying drawings, wherein:

FIG. 1 is a structural diagram of a conventional computer peripheral apparatus with a built-in USB hub;

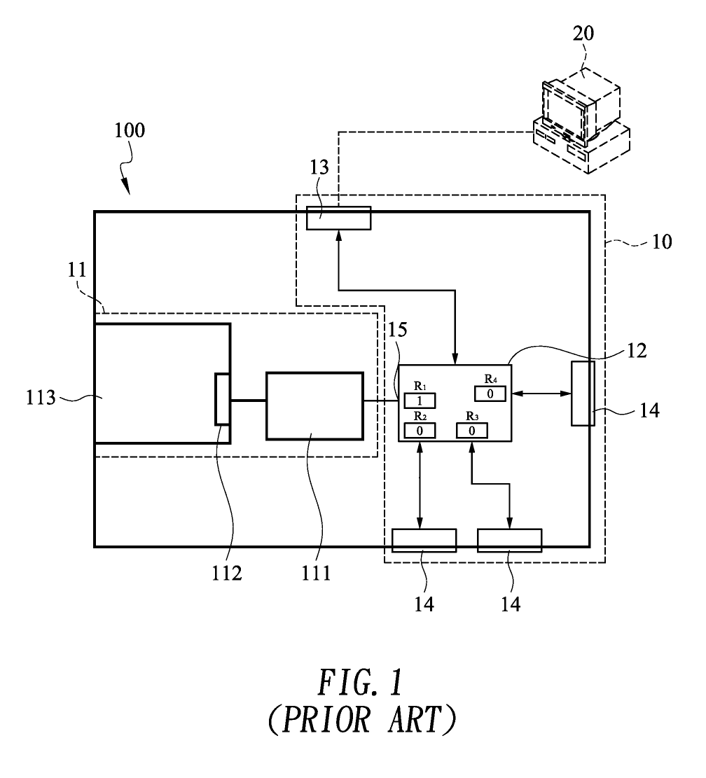

FIG. 2, according to FIG. 1, shows an external USB device connected to the conventional computer peripheral apparatus;

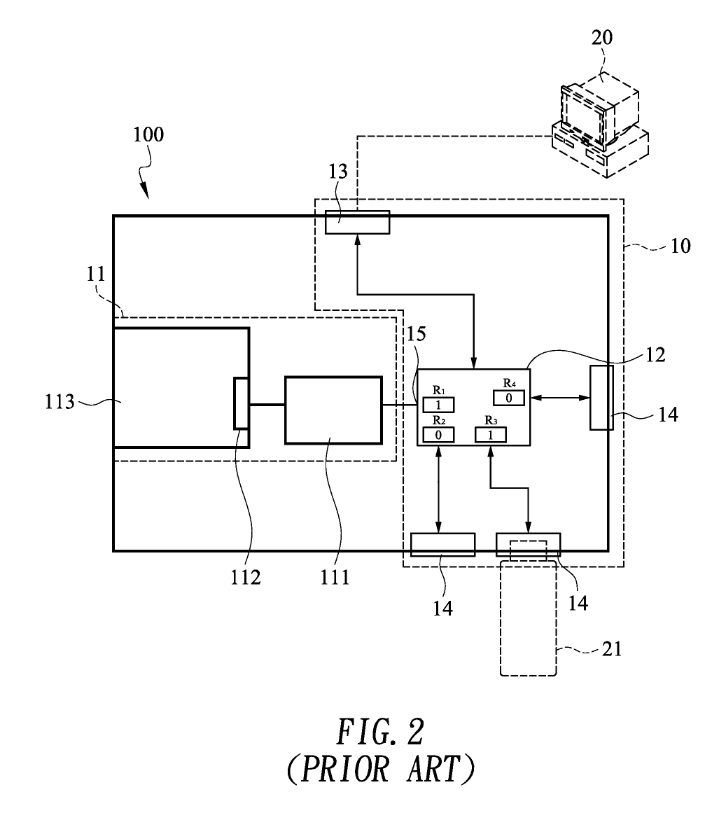

FIG. 3A is a schematic drawing of a computer peripheral apparatus according to one embodiment of the present invention;

FIG. 3B is a structural diagram of the computer peripheral apparatus of FIG. 3A;

FIG. 4A, according to FIG. 3A, shows a card to be connected to a build-in card reader of the computer peripheral apparatus;

FIG. 4B is a structural diagram according to FIG. 4A; and

FIG. 5 is a structural diagram of a computer peripheral apparatus according to another embodiment of the present invention.

### DETAILED DESCRIPTION OF THE INVENTION

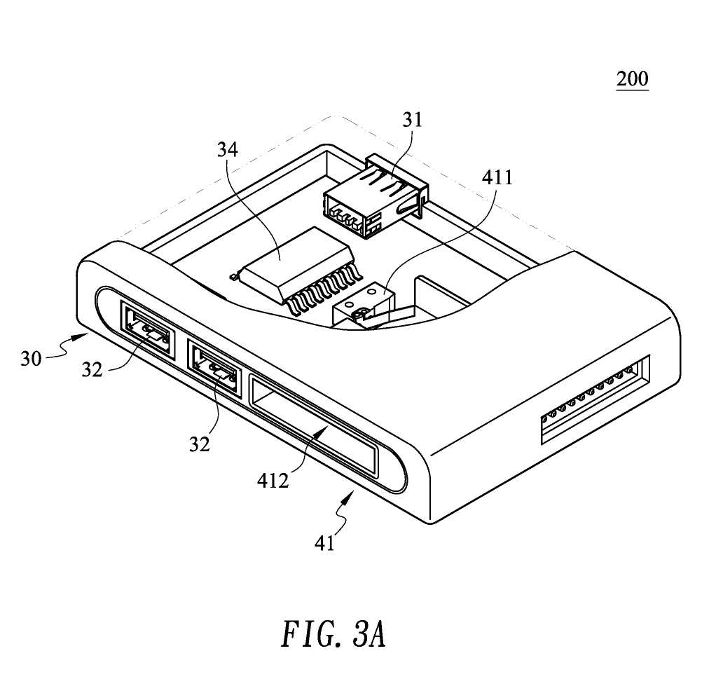

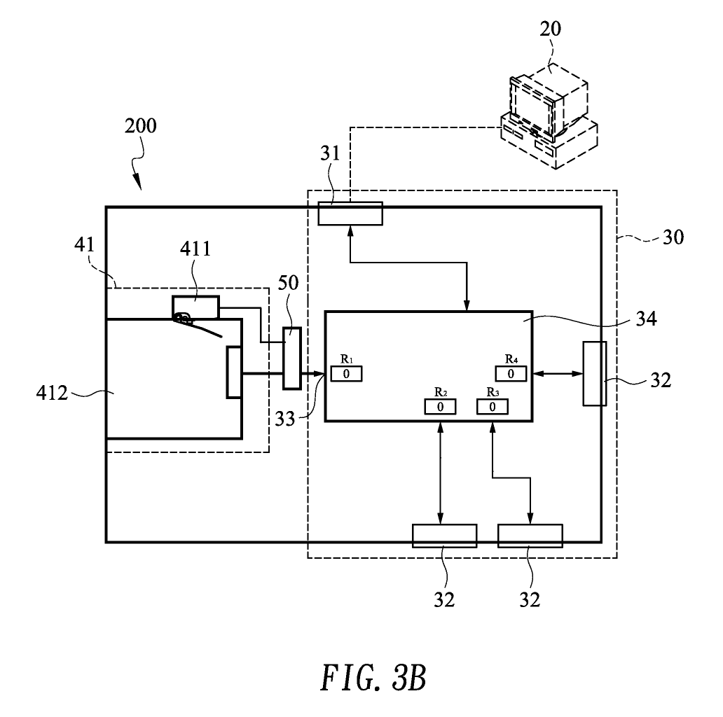

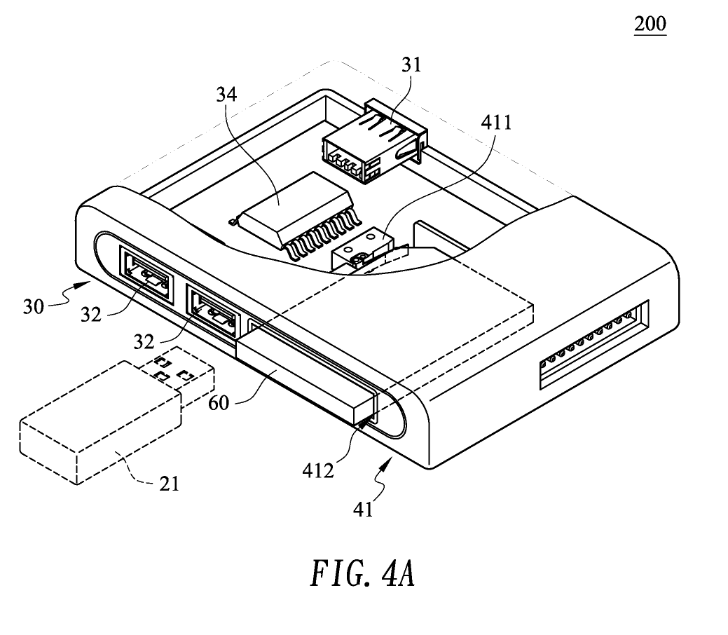

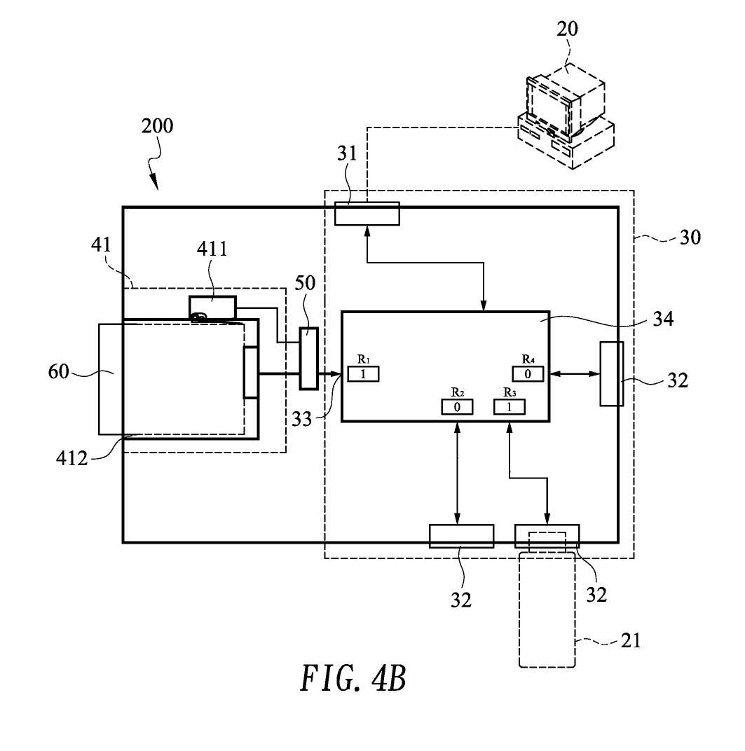

Referring to FIG. 3A through FIG. 4B, one embodiment of the present invention provides a computer peripheral apparatus 200, which integrates a build-in card reader 41 and a USB hub 30. The computer peripheral apparatus 200 overall includes the USB hub 30, at least one said build-in card reader 41, and a controller 50.

As shown in FIG. 3B and FIG. 4B, the USB hub 30 has an upstream USB port 31, at least one downstream USB port 32, and at least one built-in downstream port 33. Therein, the upstream USB port 31 is configured to be connected to a host computer 20, so as to act as an interface between the host computer 20 and the USB hub 30 for signal transmission. The downstream USB port 32 is configured to connect an external USB device 21 (shown in FIG. 4A and may be any kind of USB devices), thereby enhancing the practicability of the computer peripheral apparatus 200. The built-in downstream port 33 is electrically connected to the build-in card reader 41.

Furthermore, the USB hub 30 has a hub controlling unit 34. The hub controlling unit 34 further includes a plurality of registers, namely R₁, R₂, R₃, and R₄. Each set of said downstream USB ports 32 and said built-in downstream port 33 corresponds to one of the registers R₁, R₂, R₃, and R₄ for recording the status of the downstream USB ports 32 and the built-in downstream port 33.

Referring to FIG. 4B, when connected by one said USB device 21, the downstream USB port 32 presents a connection requirement, which turns a value of the corresponding register R₃ from 0 to 1, wherein the value as 0 denotes that the corresponding downstream USB port 32 is not connected, and the value as 1 represents that the corresponding downstream USB port 32 is connected.

The build-in card reader 41 is electrically connected to one said built-in downstream port 33, and the controller 50 is electrically connected to and controls the USB hub 30 and the build-in card reader 41. The controller 50 serves to monitor the working status of each said build-in card reader 41, or in other words, it determines whether there is a connection requirement at the build-in card reader 41.

When determining there is no connection requirement from one said build-in card reader 41, the controller 50 sets the corresponding built-in downstream port 33 as a “first status,” and compels this built-in downstream port 33 to be recognized as not connected. On the other hand, when the controller 50 determines that there is a connection requirement at one said build-in card reader 41, it sets the corresponding built-in downstream port 33 as a “second status,” and compels this built-in downstream port 33 to be recognized as connected.

Therein, when the built-in downstream port 33 is set as the first status, the corresponding register R₁ presents a value of 0, while when the built-in downstream port 33 is set as the second status, the value of its corresponding registers R₁ is 1.

Referring to FIG. 3A through FIG. 4B, for enabling the controller 50 to make foregoing determination about the connection requirement of the build-in card reader 41, the build-in card reader 41 may include a card identifying element 411 for sensing the presence of a card 60 (e.g. memory card, chip card and so on) in a card slot 412. Furthermore, the controller 50 is electrically connected to the card identifying element 411, thereby allowing the controller 50 to monitor the connection requirement from the build-in card reader 41 through the card identifying element 411. Therefore, the build-in card reader 41 may be a memory-card reader, a chip-card reader, or the like.

As reflected in FIG. 3A and FIG. 4A, the card identifying element 411 may be provided at the card slot 412 of the build-in card reader 41 and have a resilient structure. Referring to FIG. 3B and FIG. 4B, the card identifying element 411 is further electrically connected to the controller 50, so as to inform the controller 50 with signals of whether the card 60 is presented.

Referring to FIG. 3A and FIG. 3B, when there is no card 60 in the card slot 412, the card identifying element 411 sends signals to the controller 50 to report that there is no card 60. Accordingly, the controller 50 determines that there is no need to keep the build-in card reader 41 connected, and directs the hub controlling unit 34 to set the corresponding built-in downstream port 33 as the first status, thereby turning the value of the register R₁ to 0.

On the other hand, when the card 60 is inserted into the build-in card reader 41, as shown in FIG. 4A and FIG. 4B, the card 60 triggers the card identifying element 411 to send signals to the controller 50 for informing the controller 50 of presence of the card 60. The controller 50 thus can determine the build-in card reader 41 has to be connected and can then direct the hub controlling unit 34 to set the corresponding built-in downstream port 33 as the second status, thereby turning the value of the corresponding register R₁ to 1.

Basically, the card identifying element 411 first recognizes the presence of the card 60 for allowing the controller 50 to determine whether connection of the build-in card reader 41 has to be maintained, and the hub controlling unit 34 is thereby directed to set the corresponding built-in downstream port 33 as the first status or the second status, in turn setting the value of the corresponding register R₁ as 0 or 1.

When the value of the register R₁ corresponding to the built-in downstream port 33 is set as 0, it means that there is no more the connection requirement from the build-in card reader 41 and the build-in card reader 41 may be placed on standby. At this time, the hub controlling unit 34 reports to the host computer 20 that the built-in downstream port 33 is not connected, so the host computer 20 may direct the hub controlling unit 34 to shut off the built-in downstream port 33, thereby putting the build-in card reader 41 into hibernation mode.

Moreover, when values of all the registers R₁, R₂, R₃, and R₄ are 0, as shown in FIG. 3B, it indicates not only that there is no build-in card reader 41 to be kept connected, but that there is no said external USB device 21 connected to the downstream USB port 32. At this time, the host computer 20, which recognizes that all the downstream USB ports 32 and built-in downstream ports 33 are not connected, may command that the hub controlling unit 34 to enter into hibernation mode and/or the corresponding USB port at the host computer 20 to activate hibernation, thereby significantly lowering power consumption.

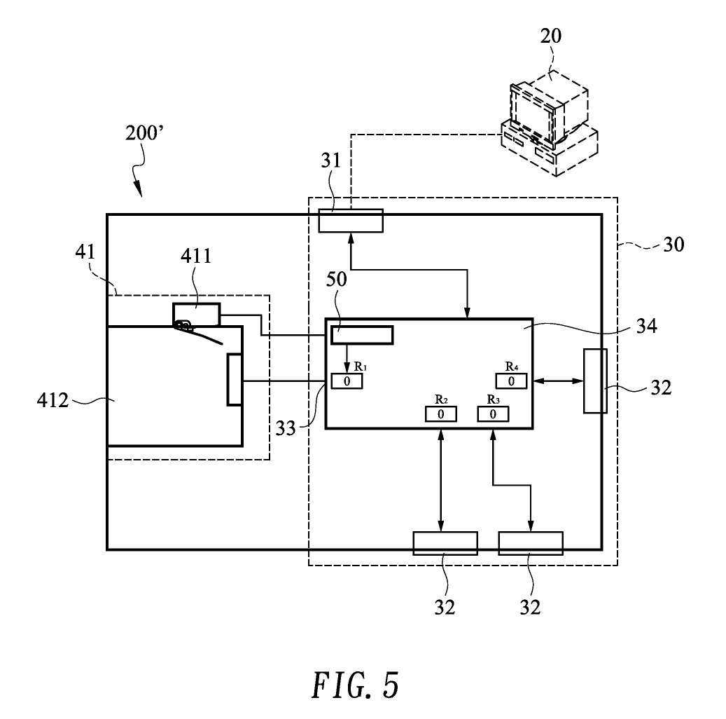

As shown in FIG. 5, the controller 50 may be alternatively integrated in the USB hub 30, and the controller 50 further integrated in the hub controlling unit 34, so that the hub controlling unit 34 is directly electrically connected to the card identifying element 411, and thus does not need to detect and interpret signal packages output by the controller 50. Such a configuration is therefore more beneficial than that illustrated in FIG. 3B and FIG. 4B from the aspect of power conservation.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A computer peripheral apparatus, which integrates at least one build-in card reader and a USB hub, the computer peripheral apparatus comprising:
the USB hub having an upstream USB port, at least one downstream USB port, and at least one built-in downstream port;
the at least one build-in card reader, each electrically connected to one said built-in downstream port; and
a controller electrically connected to and controlling the USB hub and the build-in card trader, monitoring a connection requirement of each said build-in card reader, and such operation that:
when determining that there is no said connection requirement from one said build-in card reader, the controller sets the corresponding built-in downstream port as a first status and compels the built-in downstream port to be recognized as not connected; and
when determining that the is one said connection requirement from one said build-in card reader, the controller sets the corresponding built-in downstream port as a second status and compels the built-in downstream port to be recognized as connected.

2. The computer peripheral apparatus of claim 1, wherein the build-in card reader has a card identifying element for the controller to be electrically connected thereto and monitor the connection requirement from the build-in card reader.

3. The computer peripheral apparatus of claim 2, wherein the build-in card reader is a memory-card reader and has a card identifying element for the controller to be electrically connected thereto and monitor the connection requirement from the memory-card reader.

4. The computer peripheral apparatus of claim 2, wherein the build-in card trader is a chip-card reader and has a card identifying element for the controller to be electrically connected thereto and monitor the connection requirement from the chip-card reader.

5. The computer peripheral apparatus of claim 1, wherein the controller is integrated in the USB hub.
